(19) United States
(12) Patent Application Publication
(10) Pub. No.: US 2009/0169113 A1
(43) Pub. Date: Jul. 2, 2009

(54) Automatic and Semi-Automatic Detection of Planar Shapes from 2D Images

(75) Inventor: Davi Geiger, New York, NY (US)

Correspondence Address: Ostrow Kaufman & Frankl LLP;Susan Formicola, The Chrysler Building, 405 Lexington Avenue, 62nd Floor, NEW YORK, NY, 10174, US

(73) Assignee: NHEGA, LLC, NEW YORK, NY (US)

(21) Appl. No.: 12/067,528

(22) PCT Filed: Sep. 21, 2005
(86) PCT No.: PCT/US05/34113

§ 371 Date: Aug. 28, 2008

(51) Int. Cl. G06K 9/46; G09G 5/00

(52) U.S. Cl. 382/203; 345/629

(57) ABSTRACT

A method is disclosed to digitize and recognize planar shapes that are present in images and are desired to be recognized and extracted. These planar shapes can represent maps in cartography, they can represent patterns from garment styles, they can represent projections of real objects into a 2D picture. The images are obtained from image scanning techniques including digital cameras. The invention includes an automatic mode and a user interface for the semi-automatic mode of operation. The method has been carried out for patterns that were drawn or plotted on papers (not cut out), representing garment styles, and is readily applicable to other applications such as maps in cartography, and more generally to recognition of 3D objects from 2D images. It could be use d as a module for any image processing software

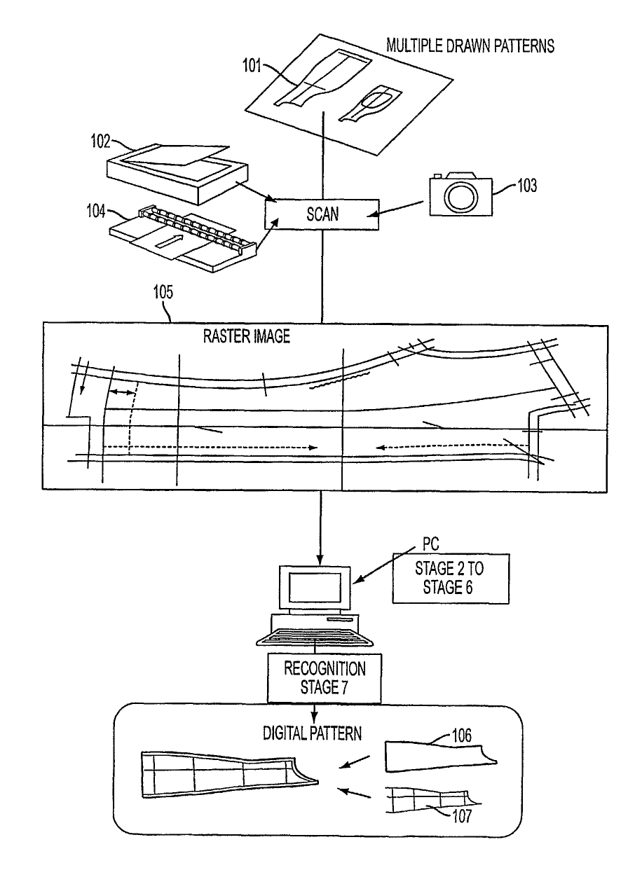

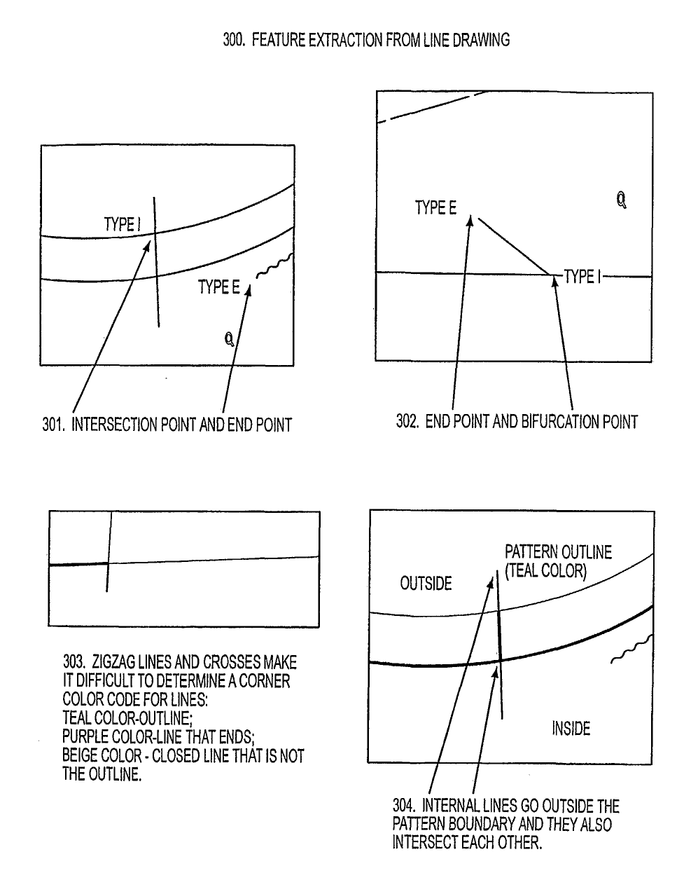

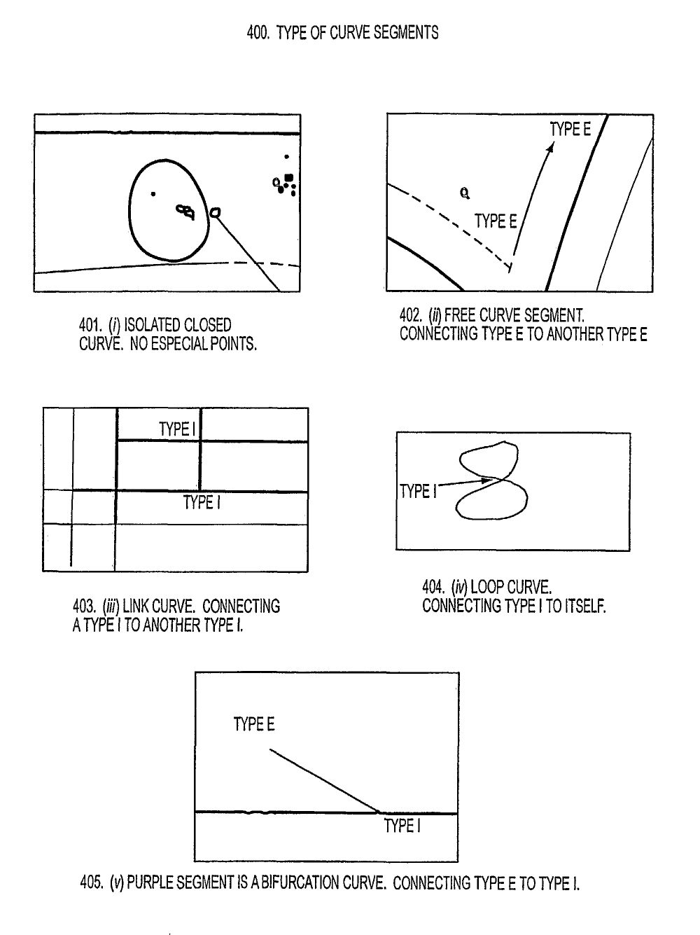

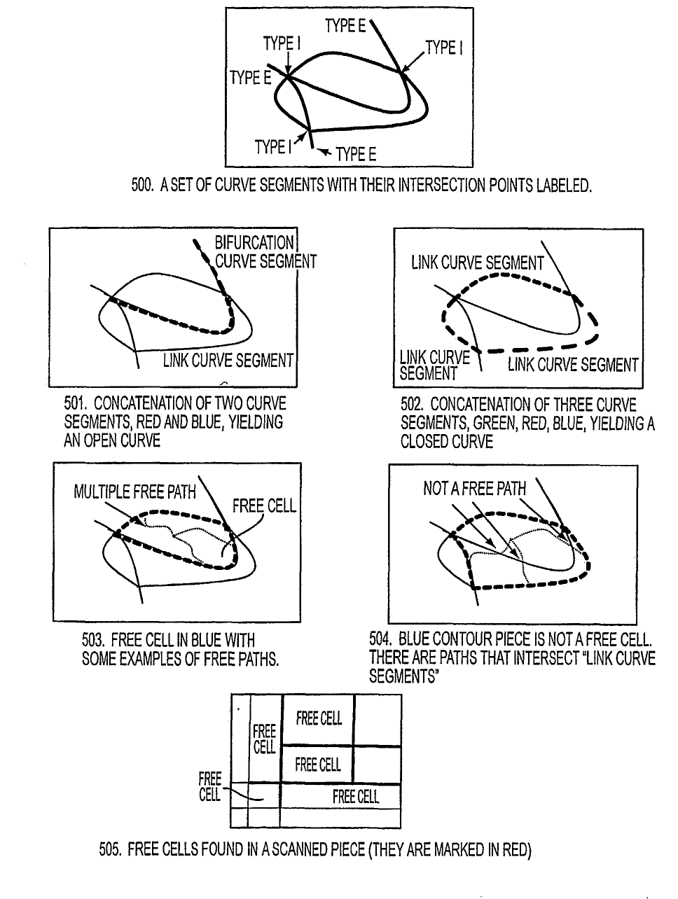

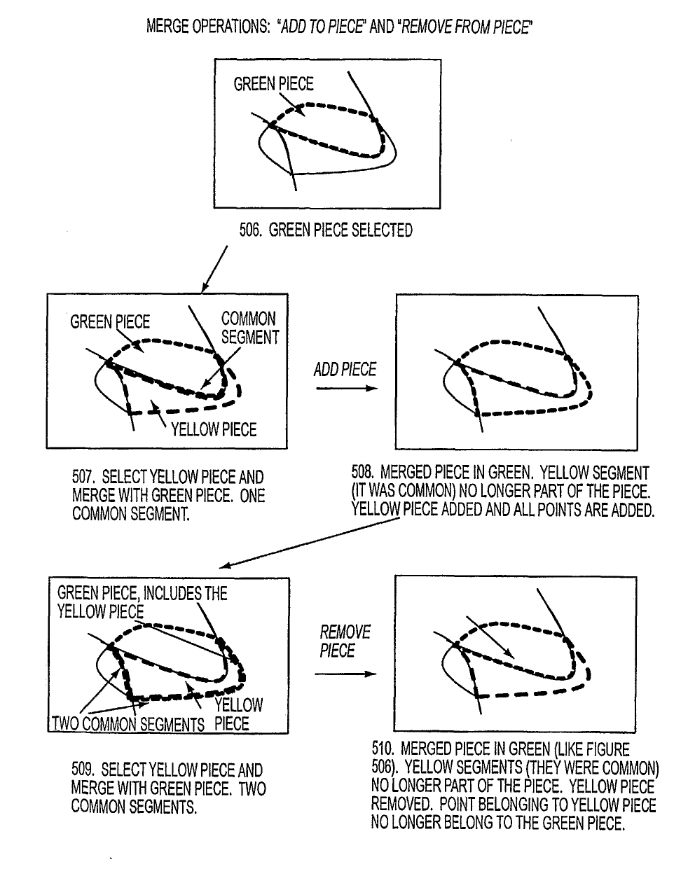

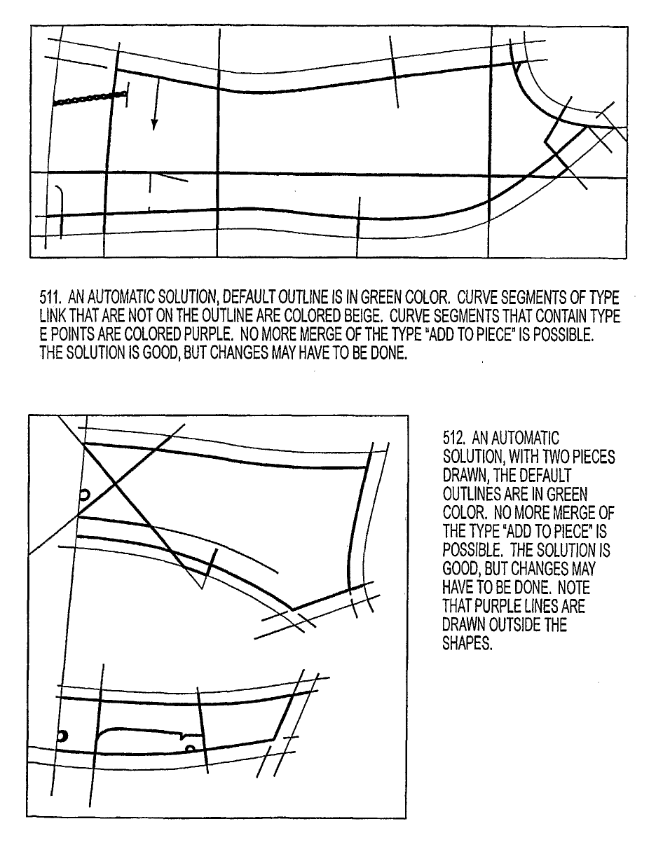

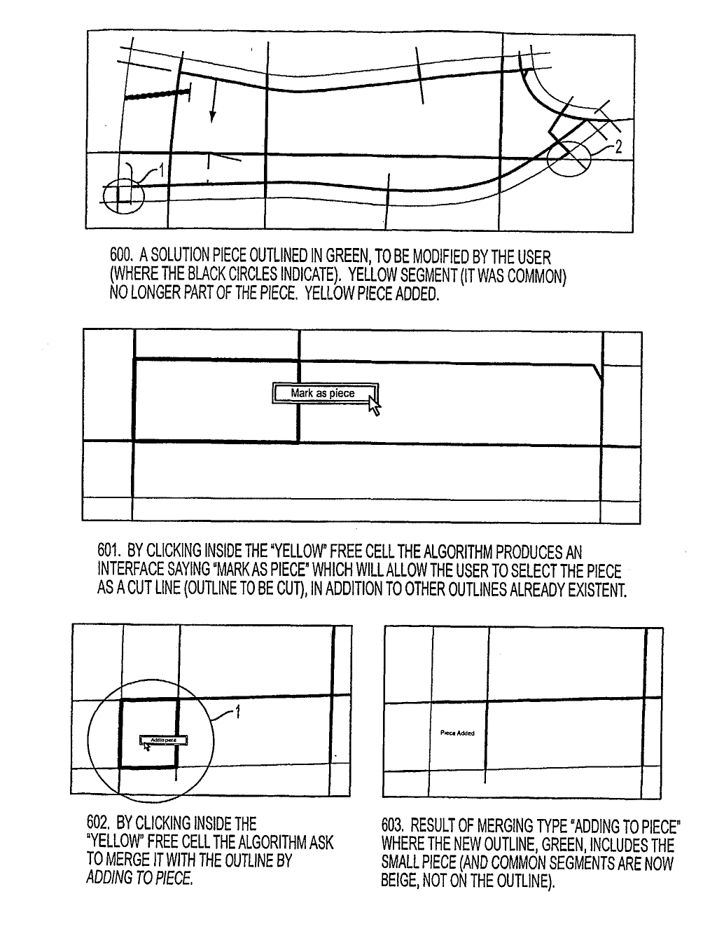

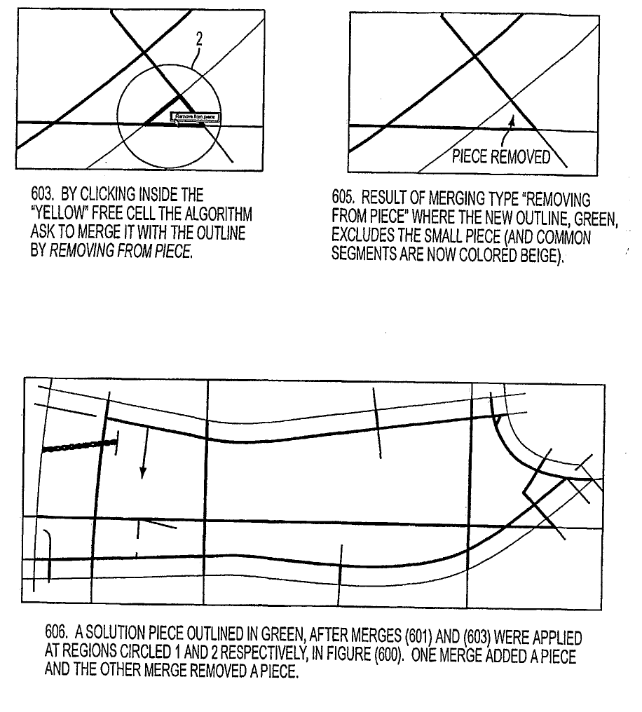

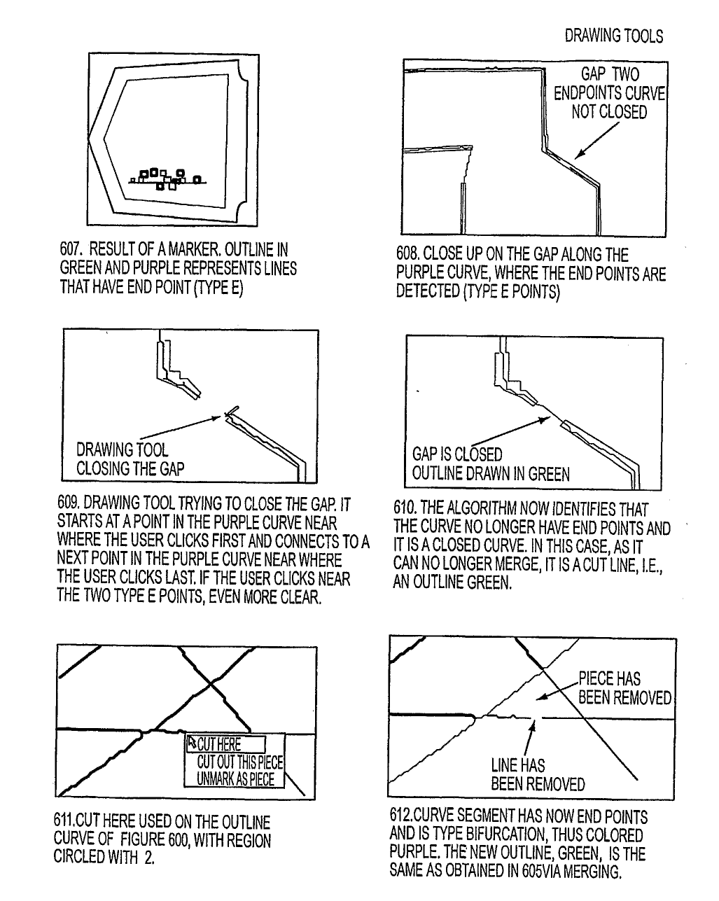

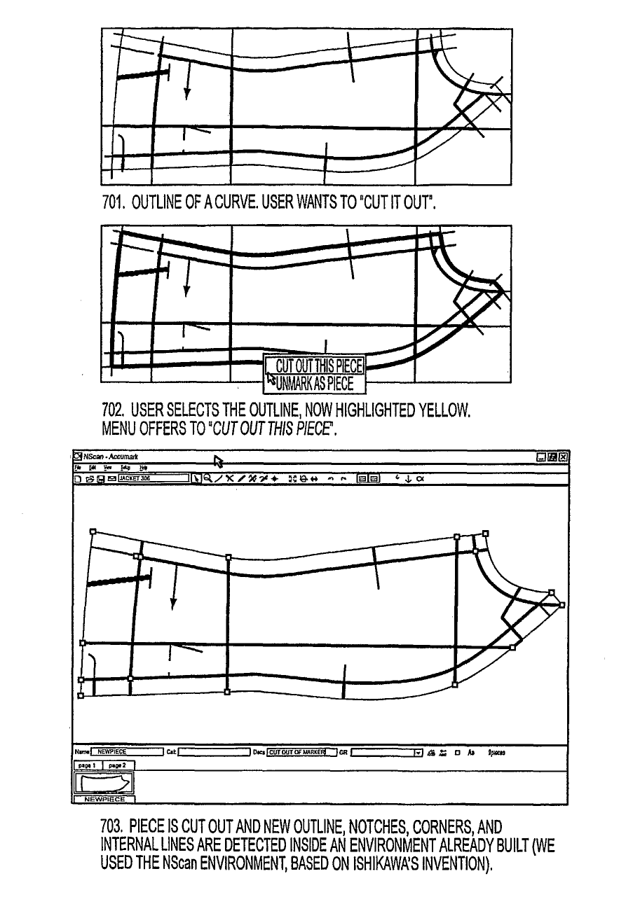

### TECHNICAL FIELD

The present invention relates to digitization of planar shapes that are present in images and are desired to be recognized and extracted. These planar shapes can represent maps in cartography, they can represent patterns from garment styles, they can represent projections of real objects into a 2D picture. The images are obtained from image scanning techniques including digital cameras. The invention includes an automatic mode and a user interface for the semi-automatic mode of operation.

The method has been carried out for patterns that were drawn or plotted on papers (not cut out), representing garment styles, and is readily applicable to other applications such as maps in cartography, and more generally to recognition of 3D objects from 2D images. It could be used as a module for any image processing software.

### BACKGROUND ART

A garment is generally made by sawing together a number of pieces of clothes. A design of a garment, then, is largely determined by the shapes of these pieces. Traditionally, pieces of thick papers with exactly the same shape and size as the pieces of clothes are used to record the shapes that determine the design of a garment. These variously shaped thick papers are called “patterns” in the industry. Many times these patterns are made by line drawing or plotted in a piece of paper that are not necessarily thick. A collection of patterns that comprise a whole garment is called a style. Many times a full style or a part of a style, i.e., many pattern pieces, are drawn in one piece of paper only. Usually each pattern drawn will not overlap with the other one, i.e., their boundary lines will not overlap. There is one class of drawings/plotted patterns, called “nested” drawings that may contain the same pattern drawn at different sizes. In these cases they overlap, one drawn is made on top of the other. Given such a style, one can make the pieces of clothes by simply copying the shape of the patterns, and then produce a garment of desired design by sewing the clothes together.

In a computerized design management system, the shape of each cloth is stored as a set of curves and lines, making a digital pattern. From such a digital pattern, it is easy to plot a life-sized shape on a piece of paper using a plotter, or even automatically cut such a shape out of paper or a cloth using a special plotter that has cutters instead of pens.

There are many benefits to such computerization of the design, such as efficient grading, marking, cutting.

This process of digitizing the physical paper with patterns has been slow and labor-intensive. Typically, the modeler fixes on a large digitizer board and the trace the contour of the pattern by pointing (with a special pointer) relevant points on the contour one by one and pushing a button that signals the digitizer board to locate and record the position of the pointer on the board.

U.S. Pat. No. 4,575,628 (1986) to Bankart, et al. teaches a pattern scanner. However, it has not been widely used partly because of its inability to automatically identify corners on the outline of patterns. The outline of the pattern is its single most important feature and the discrimination of the points on the outline into those that are corners and that are not is very important. To wit, corners are the most salient feature of the shape of the outline and also are often used as grade points. Almost all computerized design management system currently in use treat corner points differently from other points. Thus, in the prior art the user have to either digitize manually with digitizer board or use an existing pattern scanner and then mark corners manually.

U.S. patent application Ser. No. 10/492,722, titled AUTOMATIC DIGITIZATION OF GARMENT PATTERNS, awarded September 2005, Ishikawa teaches how to automatically or semi-automatically scan pattern pieces that have been cut out. We show that their method can be used to carried out the process after the last stage of our invention.

The present invention relates to this process of digitizing the physical patterns that are drawn or plotted on paper, including the case of multiple patterns being drawn or plotted on a single page. The invention goes beyond this application. In cartography, one may want to trace the boundary of regions (from maps). These regions may represent important information such as the delineation of a country boundaries, or rivers or any other information that can be perceived visually (form the images). Our invention should help this process of delineation be done more automatically. Recognizing objects from images is a well know difficult problems that eludes researchers today (see the number of paper in recognition at the international 30 conference in computer vision, ICCV2005). Our invention allows users to semi-automatically trace any object in seconds. Techniques such as the one found in Adobe PhotoShop exist, but tend to be slow and they do not take advantage that objects are closed shapes. Our invention will allow users to be more efficient in selecting objects from images, and “virtually cutting” them from images for other manipulations (such as the use the “cut out image of the object” to place in a magazine or news paper.)

### DISCLOSURE OF INVENTION

Accordingly, it is an object of the invention to provide a method to semi-automatically digitize garment patterns that are drawn or plotted on paper. It is also an object of the invention to provide a method to automatically digitize garment patterns so that the resulting data includes information on the shape of the pattern, including the identification of corners and notches. It is further an object of the invention to describe a user interface that can modify the automatic solutions to produce new solutions. Finally, it is an object of the invention to provide a method to interface the semi-automatic digitization of drawn or plotted patterns on papers with previous methods to detect shapes from cut out pieces.

The invention goes beyond the application of patterns from garments. In cartography, one may want to trace the boundary of regions (from maps). These regions may represent important information such as the delineation of a country boundaries, or rivers or any other 15 information that can be perceived visually (form the images). Our invention should help this process of delineation be done more automatically. Recognizing objects from images is a well know difficult problems that eludes researchers today (see the number of paper in recognition in the top conference in computer vision, ICCV2005). Our invention allow users to semiautomatically trace any object in seconds. Techniques such as the one found in Adobe PhotoShop exist, but are based on algorithms such as dynamic programming or Dijkstra's algorithm. They do not take advantage that objects are closed shapes. Our invention will allow users to be more efficient in selecting objects from images, and “virtually cutting” them from images for other manipulations (such as the use the “cut out image of the object” to place in a magazine or news paper.) The main distinction among different applications is the initial stage of detecting lines. In maps, color differences may be used to detect the boundaries. In images of 3D objects, even texture differences can be used to detect boundaries. Any technique to extract lines can be used in the present invention. It is an object of the invention to use the semiautomatic digitization process to apply to all these applications. We now describe the invention in stages, we have devised seven (7) stages.

### Stage 1: Scan

The first stage scans the paper where the physical pattern is drawn or plotted producing a raster image, or where maps are drawn or printed, or where the images of objects are present (101). This can be done with any of current digital imaging techniques. For instance, a flatbed scanner commonly seen in offices (102), or a CCD digital camera can be used (103). In an industrial setting, a large-format scanner (104) might be used. The result is a raster image (105), i.e., a digital facsimile of the physical pattern. Given a raster image (105) of patterns drawn or plotted from the first stage, the method extracts relevant information from it. The single most important information is to recognize each pattern by its outline (106) (there may be multiple patterns drawn or plotted). Other important features include lines and curves drawn on each pattern (107), which we call internal curves hereafter. Both the outline and the internal curves appear in the raster image as curves.

### Stage 2: Automatic Line Extraction

In the second stage the method recognizes curves in the raster image. There is more than one conceivable algorithm to detect and recognize curves. Any algorithm that robustly recognizes curves in the raster image can be used for the present invention. Such an algorithm finds characteristic pixels in the raster image that are positioned like a curve. What characterizes such a pixel depends on what kind of curves the algorithm is looking for. A pixel on an outline drawn on a paper or an internal curve is characterized by its color difference from the pattern paper color. Though such simple characterizations by themselves are not enough, they serve as local criteria to narrow down the locus of the curves. Having found a set of candidate pixels that satisfy the local criteria, the algorithm finds curves that lie on such pixels. For other applications such as maps or object recognition the characteristic of curves may be different. For maps, color differences in neighbor pixels may be used to detect the outlines. In 2D images of 3D objects, even texture differences can be used to detect boundaries. Any technique to extract lines can be used in the present invention.

The result of this stage comprises the representation of curves some of which are part of the outline and others are internal curves. In the presence of multiple patterns drawn on a piece of paper, it is not uncommon to have curves that connect different patterns and thus, some of these curves may not be internal curves nor belong to the outline curve (512). The representation is such that the coordinates of successive points on the curves can be readily calculated.

### Stage 3: Automatic Extraction of Intersection Point and End Point

There are two type of points belonging to a curve that can be extracted before the curves are extracted or after the curves are extracted. They are called “intersection points” and “end points”. Intersection points are formed when two curves intersect and sometimes they can be the location of multiple curves intersection (301). Sometimes the intersecting points are the location where curves bifurcate (302), i.e., where a curve split into two curves. In any case the intersecting point will be at a location where at least three curve segments will meet. End points are at a location where the curve does not extend (301), (302). It is arbitrary to call these points endpoints or starting point. In the present invention no distinction is made weather the end point is actually the end of the curve or the beginning of the curve. One finds many intersection points on patterns drawn or plotted. Internal curves often extend outside the outlines and often intersect each other (304). One also finds end points, where a curve ends (or begins). Sometimes even the outline is not completely drawn and end points will occur at these curves (607), (608). The algorithm must detect these intersection points and end points, and various methods can accomplish that. There are methods that can detect these points before curves are extracted and methods for after curves are extracted. Any method that accomplishes the detection of these points reliably can be used by the present invention. Typically one examines the image patterns of the nearby pixels created by end points and the pattern of nearby pixels created by intersection points. One can examine these patterns after lines where extracted (an easier task) or from the raw data without any information about curves. One also examines many other patterns (as many as possible) to distinguish these patterns from all the other patterns.

The result of this stage comprises the representation of intersecting points and end points. Coordinates are assigned to the points and a label is assigned to the points whether the point is an intersection point (type I) or and end point (type E).

Regardless of which process is done first, extracting curves or extracting points type I and type E, both processes must be done. If extracting curves is done first then points type I and type E will be extracted from the curves and will naturally be points belonging to the curve. If extracting points type I and type E is done first, then the extraction of curves must include these points as such points. Note that some closed curves do not contain any of these points (401). Our present invention applies to any method that reliably extract curves and extract points type I and type E which belong to the curves. These are output of this stage of the algorithm.

### Stage 4: Extracting the Set of Curve Segments

A curve segment is a segment of a curve that links a point of type I or E to a point of type I or E. If a curve does not contain points type I nor type E, this curve is classified as a (i) “Isolated Closed Curve” (401). Once all curves and all especial points type I or E are extracted from the images, we extract curve segments and classify them as follows: (i) 5 “Isolated Closed Curve”; (ii) Free Curve Segment: Connecting one type E point to another type E point (402); (iii) Link Curve Segment: connecting one type I point to another different type I point (403); (iv) Loop Curve Segment: connecting one type I point to itself, where a “8” loop exist (404); (v) Bifurcation Curve Segment: connecting one type I point to a type E point (405).

In order to collect all curve segments, the algorithm must sweep through all curves and for each curve it must sweep through all consecutive pair of points type E or I and for each pair of these especial points assign a curve segment, with a counter or any other index to the curve segment. The result is a set of curve segments the algorithm must assign the type of segment (according to (i), (ii), (iii), (iv), (v)) and inherit to the curve segment all curve points already ordered in the curve (between the pair of selected points). Thus, every curve segment will contain a sequence of points inherited from the original curves which was extracted (with the same ordering). It is also plausible that an algorithm is developed to detect curve segments, i.e., that curves are detected up to the detection of points type I and type E when a stop is placed. In this case, the algorithms used for curve detection can be applied with an extra condition that once a point of type E or type I is detected, it signals the end of a curve segment. Also, if the end is a type I point, it also represents the start of another curve segment or multiple curve segments. Each curve segment is then stored with its especial points type I or type E and labeled according to our classification above, from (i) to (v). Clear is that each curve segment of type (ii), (iii), (iv), 25 (v), contains two and only two especial points (type E or type I). The curve segments may explicitly say which point(s) are of type I. Note that two distinct curve segments may only contain the especial points type I in common. No other point is common to two distinct curve segments.

One can then apply either technique

1. Finding curves (stage 2) and then finding especial points (stage 3) and then finding the curve segments (stage 4) or

2. Finding curve segments and especial points on one stage

In both methods the result of this stage comprises the representation of curves segments extracted from the set of all curves and all points type E and type I. This representation includes an integer index for each curve segment (possibly a counter), the description of what type of curve segment it is, (i), (ii), (iii), (iv), (v), the description of the type of beginning and end points (type I or type E or none), the ordered sequence of coordinates of the points (which may 5 be inherited from the original curve.) Each curve segment can have its ordered sequence of coordinates reversed and either way will represent the same curve segment. This is an intrinsic ambiguity of the curve segments and any manipulation of the curve segments should take this property into account, by considering both representation and possibly fixing one representation if it is needed. Note: every point belonging to a curve has been accounted by some curve segment of the set of all curve segments.

### Stage 5: Extracting any Closed Curve and a Default Solution

An outline is a closed curve. A close curve is a curve without starting or ending point. If one makes a choice of a starting point to order the sequence of points then the last point of the sequence will be an immediate neighbor of the starting point. For a closed curve, there is no special point to start or end the curve. Examples of closed curves are curve segments of types (i) and (iv), see (401) and (404). In order to identify the outline, the algorithm must be able to produce any possible curve that is closed as a priori any closed curve can be the desired solution. Any curve segment that contains a type E point can not be part of a closed curve, otherwise why would they contain an ending point? Thus, curve segments of type (ii) and (v) will be classified as internal curves. All internal curves can be created by concatenations of curve segments such that the starting curve has a type E point as its starting point (500), (501). We define a concatenation of curve segments as an order set of curve segments such that the end point of a curve segment is the same point as the starting point of the next curve segment. Note that curve segments can be represented by having its ordered reversed, so to describe a concatenation of two curve segments one must consider both representations of each curve segment and choose the one that concatenate. The order that concatenates the segments places the end point I of a curve segment as the same point as the first point of the concatenated curve segment. Once an ordering is set, both curve segments are ordered and they can not be reversed during the concatenation of all curve segments that make a curve. Closed curves can be directly curve segments (i) and (iv), or they can be constructed by any concatenation of curve segments of type (iii) only as long as they satisfy a constraint: “Close Concatenation Constraint”. The Close Concatenation Constraint requires that the end point of the last segment of a concatenation of curve segments is also the starting point of the first segment. This constraint guarantees the concatenation of curve segments to produce a closed curve (502). Note that by construction a concatenation of curve segments of type (iii) only contains starting points and end points of type I. Only concatenation of curve segments (iii) can yield closed curves. The set of all possible closed curves, given the set of curve segments, is built from the curve segments of type (i), plus the curve segments of type (iv), plus the set of all different concatenations of curve segments of type (iii) satisfying the Close Concatenation Constraint.

In our application one does not have to show or enumerate all closed curves to reach a solution. We can guess what is the most likely candidates to be the outline by a method that does not exploit all possible closed curves and we can provide a user interface to select any other solution efficiently. Before we elaborate on an automatic process for outputting the “best outline” we describe some new processes needed for constructing closed curves.

We now describe the construction of “free cells” or “small pieces/closed contours” and a process that can “merge” pieces, including the free cells. A free cell is a region in the image, delineated (bounded) by a closed curve that have the following property: Any internal point can reach any point along the closed curve through a “free path”. A free path is a path that does not intersect any point that belongs to a curve segment of type (iii), (503), (504) and (505). A free path may intersect free curve segments (type ii) also called internal lines. Usually, free cells represent “small pieces”.

The invention requires a process we call “merge”. We define the merge process as follows: given any two pieces that contain one or more curve segments in common, merging them imply creating a new piece, a resulting piece with a resulting closed curve, such that all the curve segments belonging to both closed curves belong to the resulting closed curve, except the curve segments that were in common (506), (507), (508), (509), (510). The common curve segments are “eliminated” from the merged piece. The resulting closed curve from the merge process is a new piece. To complete the merge, we rearrange the order of the segments to satisfy the concatenation criteria needed to describe a closed curve (the ordering of the segments). The ordering is actually automatically guaranteed if one use one piece as reference and simply replacing the ordered curve segments that are common by the ordered curve segments of the other piece that were not common. Note that merging applies to any pair of pieces with common curve segments and it does not require any of the pieces to be “free cells”. Note that after merging two pieces, the resulting piece can have an area including both pieces or it can have an area that is smaller than one of the pieces. If a merge is such that for any given point inside each of the original pieces result on this point being inside the resulting merged piece, we say the merge is of the type add to piece (506), (507), (508) and (602), (603). The resulting piece is larger than both original pieces, it is as if the two pieces were added to each other. If a merge is such that points inside one of the pieces result on being outside the resulting piece, we say the merge is of the type remove from piece (509), (510) and (604), (605). The resulting merged piece is smaller than at least one of the two original pieces. It is as if one piece was removed from the original piece. It is enough to check if one point, any point, inside the curve remains inside or not after the merge to know if the merge is type add to piece or remove to piece.
It is the object of this invention to output an automatic solution (the default outlines). We define the default outline as the piece such that no merge procedure can increase its area, no merge procedure can “add to piece” (511), (512). There are different algorithms to accomplish this and any one can be used for the present invention. One possible method is to apply the merge procedure in a recurrent fashion, i.e., we start with all free cells and merge them with its neighbor pieces. Neighbor pieces are the ones that they have a common curve segment. We choose neighbor pieces in any order. Then we merge the resulting pieces as long as their merge are of the type “add to piece” and so on and so forth, until there is no more pieces to merge of the type “add to piece”. Note that multiple outlines can be detected as long as they don't have common segments, i.e., merge by “add to piece” is not possible.
Finally, in the garment industry we have the seam line. It is a closed line, inside the pattern and almost following the outline, not too far from it. It is used to sew the cloth. It is natural to have a default that when two closed curves are detected and one of them, the outside one, is the outline, the other one can be immediately labeled as the seam line. Even if a mistake is made sometimes, the user can later correct. There must be a default value of “closeness” between seam line and outline, and the user can specify such a threshold.
For maps, one may put more constraints on the stopping criteria to merge. One can use the color of the regions to merge or not two pieces. Similar colors that are desired to be added can be encouraged to merge and other s not. On real images from 3D objects, texture and other features can be used to stop or encourage merging procedure.
In general, for a 11 applications, one can not expect that the automatic solution will always work. When it does not, we elaborate on a user interface for the user to quickly select a desired outline solution.
Stage 6: A User Interface to Construct/Select Shapes from the Automatic Outline and the Extracted Set of Closed Curves.

We display the selected set of closed curve candidates in one color, say green for example, and all the other curve segments that belong to closed curves but that were not selected we use a different color, say beige (511), (512). We then allow the user to quickly make improvements if needed. It is the object of the invention the method to allow the user to select new closed curves to represent new pieces and to remove any choice of closed curve (pieces) that are not desired. Here are the descriptions of the few functions that are invented.

1. Highlighting pieces and curves: When the user clicks inside a piece (defined by a closed curve), the algorithms highlights (we choose the yellow color to highlight) the free cell containing the selected point, i.e., it provides the closed curve that contains the point selected by the user such that a “free path” exists between the selected point and any point along the on a point on a closed curve (or close to it), the algorithm highlights in yellow the current piece that contains that point as part of the closed curve describing it. This curve may not need to be the free cell curve. For example, if the user clicks the outline curve. In either case, if the selection is a free cell (small piece) or another piece, the users then have different choices of operations to manipulate with the selected piece (600), (601), (603).

2. Mark as Piece: If no curve segment of the selected piece is common to the current choice of outline (displayed in green) then the user has the choice of making that piece an outline piece (in addition to all the current outline ones) and the algorithm pops up a window offering the user “mark as piece” (600).

3. Merge Piece: If some curve segment (or multiple curve segments) is common between the selected small piece and the current outlined piece, than the user has the choice to merge the selected piece with the outline d piece. If the user chooses to merge, the algorithm will then merge the two pieces (the selected one and the outlined one) and the new resulting piece will be the new outline. Thus, due to merging, the new outline will include all the curve segments belonging to the selected piece (that were not outlined) and will no longer contain on the outline the curve segments belonging to the selected piece that were previously outlined. Before the user makes the choice of merging it or not, the algorithm will also anticipate if the merge type is “add to piece” or “remove from piece”, i.e., if the points inside the selected piece will be inside the new outlined piece or outside the new outlined piece.

3a. Add to Piece: If by merging the selected piece with the outlined piece results in the points be longing to the selected piece being added to the new outlined piece, the user interface will ask “add to piece” (602), (603).

3b. Remove from Piece: If the points inside the selected piece will end up outside the new outlined piece after merging the user interface will ask “remove from piece” (604), (605). Results of using merge functions on a piece are illustrated in figure (600), (606)

4. Drawing Tool to Connect Curves: The present invention allows the user to use the drawing functions that draw lines and multi-lines to create links between curves that were not present on the automatic process of curve extraction (607), (608). Thus, for example, the user can transform a curve with two end point (type E) into a closed curve by linking the end points with the drawing tool (609), (610). To be robust in identifying the intent of the user to use the drawing tool to link points in the curve, the algorithm will search near the pixel where the user left clicked to find a point belonging to a curve segment and thus start or end the drawing at this point (if any is found). If no curve segment point exists nearby the left clicked point in the image, the algorithm interprets the choice of the user at clicking at this point as simply starting and creating a new internal line. The user can use multiline tool in the same way as the line too. In the garment industry, a seam line is a closed line, inside the pattern and almost following the outline, not too far from it. It is natural to have built in the user interface that when two closed curves are detected and one of them, the outside one, is the outline, that the other one can be immediately labeled as the seam line. Even if a mistake is made sometimes, the user can always correct. There must be a default value of “closeness” between seam line and outline, and the user can specify such a threshold. Thus in figure (607), the initial green line is the seam line and so once the solution (610) is found and the outline is detected, the algorithm can automatically convert the “internal” green line into beige (or into seam line).

5. Cut Curve Segments: The present invention allows the user to “cut here” a curve segment, deleting a point and a few (consecutive) neighbor points along the curve segment (the precise number of points to be eliminated can be adjusted by the user or be a default value. We used 5 pixels for the present testing of the invention). The results of the cut is that a curve segment is split into two curves and type E points are introduced, one on each ending of the new curve segments. In this way closed curves can be “cut here” (and no longer be closed) by simply cutting one of their curve segments (611),(612). This tool complements well the “remove from piece” and “add to piece” tools, even if sometimes a task can be accomplished by either using one or the other tool, i.e., even if they are redundant. Different users may find easier different ways to reach the same solution (604), (605) or (611),(612).

In summary, the user interface offer the options for the user to construct/select its own piece (or pieces) solution once the initial default automatic solution is outlined. It is an object of the invention the new tools offered for the user to easily construct/select the piece (or pieces). For the user, we provide an environment where the user can quickly and efficiently select pieces and combine pieces (adding them or removing them) or the user can “cut” curves and so destroy pieces or draw lines that complete curves to construct new pieces. The user can then build any solution they want, very quickly. It is based on ideas that objects are closed curves and manipulations of the shapes should encourage the user playing with the concepts of closed curves as we just described. More precisely the operations include “mark piece” to select free cells and any other piece to introduce cut lines on it, the Merging tool with its two options (“remove from piece” and “add to piece”), which are automatically produced, the drawing tool (lines and multi-lines) to add new curve segments to complete closed curves (and search for nearby curve points) and to simply draw new lines, the “cut here” tool to delete a few points from a curve segment and destroy closed curves, i.e., usually used to “open” a closed curve. With these tools any shape can be recognized/constructed very efficiently.

### Stage 7: Final Output for the Outline and Internal Lines and the User Interface

Algorithms that extract lines automatically will tend to create non-smooth curves. The drawing of a pencil have a certain thickness such that tracing darker pixels will tend to make the lines jagged everywhere and the detection of corners may not be robust (303). Tracing color boundaries in maps may also give “zig-zag” shapes (303), and various techniques that focus on extracting curves may not detect corners and not yield smooth curves. In these cases, one can add a new process that extracts an outline that is accurate to the drawing and it is made of smooth curves, unless a corner is present. Additionally, the digital pattern may include other accompanying data such as an identification number, date of production, and any other characteristic, which can be entered to the system manually. It may even include the original raster image so that, should a mistake in the second stage be discovered later, the recognition can be redone, perhaps with a different set of parameters. Also, the user may be interested in extracting shape by shape from the initial raster image. It is an object of the invention a user interface where the user can click on an outlined piece (colored green) (701), the program highlights the outline yellow and a menu allows the user to choose to “cut out this piece” (702), which will send the outline piece to an environment that process images of pieces that are cut out and scanned in (703). Thus, when the user chooses to “cut out this piece” the program environment will treat it as if it was a physically cut out piece that has been scanned in. In this new environment made for cut out pieces, the detection of smooth shapes, the detection of corners, the detection of features that are particular to each application may have been already developed and used for these cases (the cases where the shapes were physically cut out before scanning). For the garment industry these extra features include the automatic detection of notches, the automatic detection of drill holes, the automatic description of the curves by as few points as each CAD system interpolation function allows to have it and any other feature already present in this environment. For example, Ishikawa's invention already teach us how to do these processes for garment patterns, and a real environment that scan pieces already exists. It is an object of this invention the user interface that includes a new function, “cut out this piece”, that allows the use r to send the outline of shapes to another environment that specializes on pieces that were already cut out when they were scanned. The final output of this stage, is the final description of the shape with its outlined and all lines in a vectorized form as the users would like to have them, with all features detected as they are needed for the application at hand.

### DESCRIPTION OF DRAWINGS

There are 10 pages with drawings or figures numbered and a description of each drawing and figure is given just below the drawing or figure. The first digit on the numbers refers to the stage of the process, from 1 to 7.

### BEST MODE FOR CARRYING OUT THE INVENTION

Here, an embodiment of the present invention is described in detail. The embodiment is a standard PC system equipped with a scanner. The hardware configuration is an ordinary one that is available from computer equipment vendors and can be easily configured by a person skilled in the art.

### Scan

A physical pattern is scanned by the scanner and sent to the PC and stored in a bitmap format. The format can be any known or proprietary format. In the following, we assume that the background of the scanned image appears in a specific color (e.g., black) that is different than the outline of the paper where the drawings or images are of interest.

### Recognition

The 6 stages up to the recognition stage, which extracts relevant information from the bitmap image, is realized as a computer program that runs on the PC system. The program loads the scanned bitmap image and produces a computer file that stores the extracted data. In this embodiment, the outline of the patterns, which are the most important feature of the physical pattern, is extracted.

The outline of a pattern is its most important feature, since the cloth would be cut according to the outline. It is a map or region needed by application in carthography. It is the outline of an object in an image. Accordingly, it is most important for the system to precisely identify the outline of the pattern. To achieve the most precise and robust performance, the embodiment employs a special method just for detecting the outline that uses special properties of outlines. The method exploits the fact that an outline is always a single closed curve. It also uses the information about the colors of the background and the pattern.

### Data Structures

We have described it as we described each stage of the algorithm, of the process to extract the outline. Some of the points are: Representing end points, intersection points, then curve segments. Then being able to concatenate curve segments and represent as such, and being able to select closed concatenations. Creating and identifying free cells. Creating programs to merge by adding and by removing pieces, programs to cut here, to mark pieces. Creating programs to recurrently add pieces with its neighbors to create a default outline solution. Finally sending the outline to an environment previously created to detect shapes. Throughout the stages, 1 to 7, we have outlined the representation needed for each of these stages. A programmer skilful in the art can reproduce the data structure and methods.

### INDUSTRIAL APPLICABILITY

While only certain preferred features of the invention have been illustrated and described herein, many modifications and changes will occur to those skilled in the art. For instance, holes on the patterns can be found in essentially the same way. Also, after the curves are identified, they may be smoothed. For instance, one can fit parametric curves such as spline or Bezier curves to the digitized curves. Here it is important to know where corners are, as it is possible in the present invention, because in these parametric curves, corners are treated differently as points where tangent vectors can change discontinuously. The explicit representation of the outline in the digital pattern may then be the parameters of the parametric curves.

Furthermore, the disclosed method can be used to digitize any shapes that are not necessarily garment patterns. Patterns that are used to produce shoes, bags, and other sewed goods are only some of more obvious examples of the shapes for which the invention can be used. Maps and images of 3D objects are more general examples.

It is, therefore, to be understood that the appended claims are intended to cover all such modifications and changes as fall within the true spirit of the invention.

We claim:

1. A method of digitizing line drawn or plotted shapes, said method comprising the steps of:
receiving at least one data representing at least one shape,
identifying at least one outline of the at least one shape in the at least one data.

2. A system for digitizing shapes, said system comprising:
a memory arrangement including thereon a computer program; and
a processing arrangement which, when executing the computer program, is configured to:
receive at least one data representing at least one shape;
identify at least one outline of the at least one shape in the at least one data, and
identify at least one corner of the at least one outline.

3. A software storage medium which, when executed by a processing arrangement, is configured to digitize shapes, said software storage medium comprising: a software program including:
a first module which, when executed, receives at least one data representing at least one shape,
a second module which, when executed, identifies at least one outline of the at least one shape in the at least one data.

4. A computerized method for recognizing objects in a digitized image containing drawn or plotted shapes, the method comprising:
receiving a data set representing one or more of the shapes in the digitized image;
extracting a plurality of curve segments from the data set; and
detecting an outline for at least one shape in the image using one or more of the extracted curve segments,

5. The method of claim 4, wherein extracting curve segments comprises detecting one or more curves in the data set.

6. The method of claim 5, wherein extracting curve segments comprises extracting points in the detected curve(s).

7. The method of claim 6, comprising identifying whether each extracted point represents an intersection point formed at an intersection of two or more curves or an end point formed at a location where a curve does not extend further.

8. The method of claim 7, wherein extracting curve segments comprises detecting segments of the extracted curve(s) that extend between two extracted points.

9. The method of claim 8, comprising classifying each curve segment based on the types of points between which it extends.

10. The method of claim 9, wherein detecting the outline comprises detecting the outline based on the classifications of the curve segments.

11. The method of claim 4, wherein detecting the outline comprises detecting a closed curve formed by one or more curve segments.

12. The method of claim 4, wherein detecting the outline comprises merging two or more curve segments into the outline.

13. The method of claim 4, comprising displaying the detected outline to a user on a display device.

14. The method of claim 13, comprising allowing the user to choose the outline for processing.

15. The method of claim 13, comprising allowing the user to choose a different set of curve segments than the curve segments in the detected outline, to thereby form a second outline.
